(19) United States
(12) Patent Application Publication
(10) Pub. No.: US 2019/0389276 A1
(43) Pub. Date: Dec. 26, 2019

(54) HEATING, VENTILATING AND/OR AIR-CONDITIONING SYSTEM FOR A MOTOR VEHICLE

(71) Applicant: VALEO KLIMASYSTEME GMBH, Bad Rodach (DE)

(72) Inventors: Michael Schramm, Bad Rodach (DE); Bodo Gesell, Bad Rodach (DE); Peter Koch, Bad Rodach (DE); Heiko Reiss, Bad Rodach (DE); Anton Herzog, Bad Rodach (DE); Siegfried Derx, Bad Rodach (DE)

(73) Assignee: VALEO KLIMASYSTEME GMBH, Bad Rodach (DE)

(21) Appl. No.: 16/479,048

(22) PCT Filed: Jan. 17, 2018
(86) PCT No.: PCT/EP2018/051070

§ 371 Date: Jul. 18, 2019

(30) Foreign Application Priority Data
Jan. 18, 2017 (DE) 20 2017 100 240.3

(51) Int. Cl. B60H 1/00

(52) U.S. Cl. CPC B60H 1/00964; B60H 1/0073

(57) ABSTRACT

Heating, ventilating and/or air-conditioning system for a motor vehicle, comprising a control device (12), at least one functional component (16) and at least one driver device (14) which is implemented separately from the control device (12) and from the at least one functional component (16), wherein the control device (12) is connected to the at least one driver device (14) in terms of information technology by means of a bus system (18), and wherein the driver device (14) has at least one driver (24) for the functional component (16), which can operate the functional component (16)

The invention relates to a heating, ventilating and/or air-conditioning system for a motor vehicle.

Heating, ventilating and/or air-conditioning systems (HVAC) for motor vehicles are known and usually have a large number of flaps and sensors. In order to increase the comfort of the occupants of the motor vehicle, it is known for the flaps to be operated via a control device by means of electric motors.

The vehicle occupant transfers his commands to the air-conditioning system via a man-machine interface of the control device, such as a touch-sensitive display or a knob. This command is then processed by the control device and the electric motors are activated accordingly by the control device.

Use is usually made of electric motors which themselves have a driver and controller, or driverless electric motors.

Electric motors which themselves already have a controller and a driver need only a digital or analogue control signal from the control device. As a result, the electric motors can be connected to the control device in terms of information technology via a bus, for example a Lin-bus, by means of a single cable strand. For example, for communication via the bus these electric motors need a microcontroller and a data memory and a driver for operating the actual motor component, such as a rotor-stator subassembly. The controllers are usually implemented as an application-specific integrated circuit (ASIC), which make up a major part of the costs of the overall electric motor. Thus, by using the bus system, it is possible to save cable and weight but the electric motors are more complex and more expensive.

In the case of driverless electric motors, the electric motor comprises only the actual motor component, such as a rotor-stator subassembly, which is connected directly to the control device. The control device supplies the motor components directly with the power necessary for the operation, so that each electric motor must be connected individually to the control device. As a result, because of the large number of electric motors, many long cables are needed, which increases the weight of the heating, ventilating and/or air-conditioning system.

It is therefore an object of the invention to provide a heating, ventilating and/or air-conditioning system which both has a simple and lightweight structure and is also economical.

The object is achieved by a heating, ventilating and/or air-conditioning system for a motor vehicle comprising a control device, at least one functional component and at least one driver device which is implemented separately from the control device and from the at least one functional component. The control device is connected to the at least one driver device in terms of information technology by means of a bus system, and the driver device has at least one driver for the functional component, which can operate the functional component.

Within the context of this invention, functional components are understood to mean the actual physically active components of electric motors and sensors, that is to say the actual actuators or measuring probes. For example, the functional component of an electric motor is the actual motor component, that is to say for example a rotor-stator subassembly. In the case of a sensor, the functional component is the actual sensor component or the measuring probe, that is to say in the case of a temperature sensor, for example, the thermistor. The functional components are preferably driverless, i.e. they themselves have no driver, controller or application-specific integrated circuits (ASIC). Accordingly, the functional components preferably have no inputs and outputs for control signals. The driver for the functional components is the driver provided in the driver device.

The invention is based on the idea of arranging the driver physically separately from the functional component, without the driver being provided in the control device of the overall heating, ventilating and/or air-conditioning system, but can be formed in a driver device provided for the purpose.

The driver device in turn can be connected in a weight-saving manner to the control device by means of a bus system, so that despite driverless functional components, the complexity and the weight can be kept low. In this way, the control device can transmit control signals to the driver devices via the bus system, which in turn operate the functional components by means of their drivers.

Preferably, the functional component has only a power connection as interface, which is connected electrically to the driver by means of a cable. The power connection and the cable are generally multi-cored. The driver can therefore represent the single power supply for the functional component and, as a result, operate the functional component without further electronics on the functional component.

The functional component can be an actuator, in particular an actuator for actuating a flap of the heating, ventilating and/or air-conditioning system and/or an actuator for a fan of the heating, ventilating and/or air-conditioning system. For example, the actuator is a stepping motor, a DC motor, a piezoelectric motor or another electric motor. As a result, the function of the heating, ventilating and/or air-conditioning system can be controlled conveniently.

In order to collect data in a simple way, the functional component can be a measuring probe of the heating, ventilating and/or air-conditioning system. For example, the measuring probe is a temperature probe or a humidity probe which, together with the driver, forms a sensor such as a temperature sensor or a humidity sensor.

In one design variant, the control device has a man-machine interface, by which means the vehicle occupants can operate the heating, ventilating and/or air-conditioning system simply. One or more displays, knobs or the like can be used as man-machine interface.

The driver device preferably has a control unit, which is connected to the bus system and which controls the at least one driver, by which means a reliable and economical connection between the driver and the bus system can be produced.

For example, the control unit is designed to control the drivers in a coordinated manner in such a way that the drivers coordinate the functional components, in particular operate them simultaneously. For example, flaps can as a result be moved simultaneously or in a specific order. Thus, comfort functions or circulation programs of the heating, ventilating and/or air-conditioning system can be realized.

In order to save weight through cabling, the distance between the control device and the driver device can be greater than the distance between the driver device and the functional component. The distance can be determined by the cable lengths between the individual components.

For example, in an air-conditioning system having multiple functional components, the distance between the driver device and the control device is greater than most, in particular all, of the distances between the functional components and the driver device.

In one embodiment of the invention, the heating, ventilating and/or air-conditioning system has multiple functional components, which are connected to the driver device. As a result, multiple functional components can be operated by using only one driver device, so that the complexity of the air-conditioning system is reduced further.

In order to save further electronic components, at least two functional components, preferably all the functional components, can be connected to the same driver, which can operate both, preferably all, the functional components.

It is conceivable that some functional components have their own driver, other functional components being operated via a common driver.

Preferably, the driver is configured to operate the at least two functional components chronologically one after the other, by which means multiple functional components can be operated by only one driver in an efficient way.

In one design variant, the driver device has multiple drivers for functional components, which means the number of control units and therefore the quantity of costly hardware can be reduced.

For example, the heating, ventilating and/or air-conditioning system can have multiple driver devices, which are connected to the control device and to one another in terms of information technology via the bus system, so that the communication of the driver devices with one another and with the control device is implemented in a manner saving space and weight.

The heating, ventilating and/or air-conditioning system can have a sensor and/or an actuator with its own controller and driver, which is connected to the control device and the at least one driver device via the bus system, which means that the heating, ventilating and/or air-conditioning system is suitable for sensors and actuators of any type.

Further features and advantages of the invention can be gathered from the following description and from the appended drawing, to which reference is made. In the drawing:

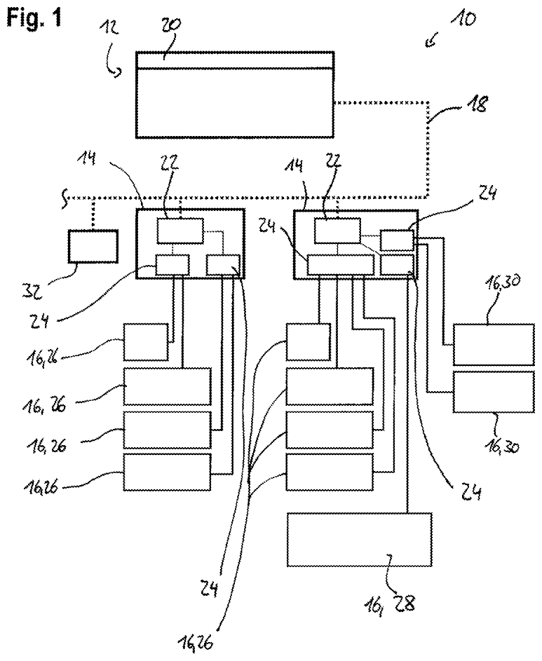

FIG. 1 shows a schematic circuit diagram of a heating, ventilating and/or air-conditioning system according to the invention.

In FIG. 1 a heating, ventilating and/or air-conditioning system for a motor vehicle, which in the following text is merely called an air-conditioning system 10, is schematically illustrated.

The air-conditioning system 10 of the exemplary embodiment has a control device 12, two driver devices 14, 11 functional components 16 and a bus system 18.

The control device 12 controls the air-conditioning system 10 and accepts commands from the vehicle occupants and/or other vehicle components, such as the control system of the engine for driving the motor vehicle.

For the purpose of interaction with the vehicle occupants, the control device 12 has a man-machine interface 20 which, for example, has a display and multiple knobs.

By means of the bus system 18, which is illustrated dotted in the figure, the control device 12 is connected to the driver devices 14 in terms of information technology.

In the exemplary embodiment shown there are two driver devices 14, which each have a control unit 22 and multiple drivers 24. The control unit 22 comprises, for example, a microcontroller having a memory.

The control unit 22 is connected to the bus system 18 and can thus receive signals from the control device 12 or the other driver device 14.

In addition, the control unit 22 is connected electrically to the drivers 24 of the respective driver device 14.

For example, the left-hand of the two driver devices 14 in the figure has two drivers 24, and the right-hand driver device 14 has three drivers 24, which are each connected to the respective control unit 22.

The functional components 16 are connected electrically to the drivers 24.

The functional components 16 are the actual physically active components of electric motors and sensors, that is to say the actual actuators or measuring probes.

Some of the functional components 16 are motor components, that is to say rotor-stator subassemblies for a stepping motor, a DC motor, a piezoelectric motor or another electric motor. The functional components 16 are themselves driverless, i.e. they themselves have no driver, controller or application-specific integrated circuits (ASIC). Accordingly, they have no inputs and outputs for digital or analogue control signals, that is to say signals which contain information.

Only with the respective driver 24 and the respective control unit 22 of the driver devices 14 do the functional components 16 form a sensor, electric motor or the like that can be actuated via the bus system 18.

For example, the functional components 16 of the embodiment shown are actuators 26 for actuating a flap (not shown) of the air-conditioning system 10 or actuators 28 for a fan of the air-conditioning system 10.

In addition, some of the functional components 16 can be measuring probes 30, for example, such as a temperature probe, thermistor or humidity probe, which then, together with the driver 24, form a sensor such as a temperature sensor or a humidity sensor.

The functional components 16 have only a power connection as interface, so that the connection between the functional components 16 and the drivers 24 is made by a cable.

The power connection and the cable are generally multi-cored, so that a closed circuit can be formed between the driver 24 and the functional component 16. The drivers 24 thus represent the power supply for the functional components 16.

In order that the drivers 24 can provide sufficient power for the functional components 16, the drivers 24 are connected to the on-board power supply (not shown) of the vehicle.

It is possible for multiple functional components 16 to be connected to the same driver 24. However, it is additionally conceivable that special functional components are solely connected to a single driver 24.

In the exemplary embodiment shown, this is the case for the actuator 28 for a fan, since the latter must be operated separately from the actuators 26 for the flaps.

In the motor vehicle, the control device 12, driver devices 14, functional components 16 are arranged separately, that is to say physically separated from one another.

The driver devices 14 are arranged in the vehicle in relation to the functional components 16 in such a way that the distance between the control device 12 and the driver devices 14 is greater than most, in particular all, of the distances between the functional components 16 and the respectively associated driver 24 or the respectively associated driver device 14. The distances are, for example, determined via lengths of the cables which connect the respective components.

For example, the control device 12 is provided in or on the dashboard of the vehicle interior, in order that a vehicle occupant can operate the man-machine interface 20.

On the other hand, the functional components 16 are provided directly on the flaps, fans, measuring points or the like assigned to them in the air-conditioning system 10.

The driver devices 14 are then likewise located in the air-conditioning system 10 in the vicinity of the functional components 16, in particular in the vicinity of groups of functional components 16.

In this way, the cables between the driver devices 14 and the functional components 16 can be kept short. As a result, it is possible to save weight, since the long paths between the control device 12 and the driver device 14 are covered by means of the efficient and lightweight cable of the bus system, whereas heavy and complicated cabling is necessary only on the short paths between the driver devices 14 and the functional components 16.

Of course, in addition to the functional components 16, it is possible to provide further sensors or actuators 32, which each have an individual driver and a microcontroller and are connected directly to the bus system 18. The microcontroller can be an integrated circuit.

During the operation of the air-conditioning system 10, the control device 12 can control the function of the air-conditioning system 10 by sending out via the bus system 18 control signals which have control information for individual functional components 16.

The control units 22 of the driver devices 14 receive the control signal and determine whether the functional components 16 which are to be addressed are connected to their driver device 14.

If this is the case, then the corresponding control unit 22 sends a signal to the associated driver 24.

The driver 24 in turn then supplies the corresponding functional component 16 with power, for example in order to move a flap of the air-conditioning system 10 over the angle specified in the control signal, or to read a measuring probe 30.

If two functional components 16 which are connected to the same driver 24 are to be actuated, the driver 24 can operate the functional components 16 chronologically one after another.

If more complex functional changes of the air-conditioning system 10 are to be carried out, for example resetting multiple flaps in order to de-ice the windscreen, the control unit 22 can activate the drivers 24 of the corresponding functional components in a coordinated manner. Thus, the drivers 24 can operate the individual functional components 16 in a coordinated manner, in particular simultaneously, so that a specific order can be maintained or components can be moved simultaneously.

1. A heating, ventilating and/or air-conditioning system for a motor vehicle, comprising:
a control device;
at least one functional component; and
at least one driver device which is implemented separately from the control device and from the at least one functional component,
wherein the control device is connected to the at least one driver device in terms of information technology by means of a bus system, and
wherein the driver device has at least one driver for the functional component, which can operate the functional component.

2. The heating, ventilating and/or air-conditioning system for a motor vehicle according to claim 1, wherein the functional component has only one power connection as interface, which is connected electrically to the driver by a cable.

3. The heating, ventilating and/or air-conditioning system for a motor vehicle according to claim 1, wherein the functional component is an actuator for actuating a flap of the heating, ventilating and/or air-conditioning system and/or an actuator for a fan of the heating, ventilating and/or air-conditioning system.

4. The heating, ventilating and/or air-conditioning system for a motor vehicle according to claim 1, wherein the functional component is a measuring probe of the heating, ventilating and/or air-conditioning system.

5. The heating, ventilating and/or air-conditioning system for a motor vehicle according to claim 1, wherein the control device has a man-machine interface.

6. The heating, ventilating and/or air-conditioning system for a motor vehicle according to claim 1, wherein the driver device has a control unit, which is connected to the bus system and which controls the at least one driver.

7. The heating, ventilating and/or air-conditioning system for a motor vehicle according to claim 6, wherein the control unit is configured to control the drivers in a coordinated manner so that the drivers coordinate the functional components to operate them simultaneously.

8. The heating, ventilating and/or air-conditioning system for a motor vehicle according to claim 1, wherein the distance between the control device and the driver device is greater than the distance between the driver device and the functional component.

9. The heating, ventilating and/or air-conditioning system for a motor vehicle according to claim 1, wherein the heating, ventilating and/or air-conditioning system has multiple functional components, which are connected to the driver device.

10. The heating, ventilating and/or air-conditioning system for a motor vehicle according to claim 9, wherein at least two functional components are connected to the same driver, which operates both the functional components.

11. The heating, ventilating and/or air-conditioning system for a motor vehicle according to claim 10, wherein the driver is configured to operate the at least two functional components chronologically one after another.

12. The heating, ventilating and/or air-conditioning system for a motor vehicle according to claim 9, wherein the driver device has multiple drivers for functional components.

13. The heating, ventilating and/or air-conditioning system for a motor vehicle according to claim 1, further comprising: multiple driver devices, which are connected to the control device and to one another in terms of information technology via the bus system.

14. The heating, ventilating and/or air-conditioning system for a motor vehicle according to claim 1, further comprising a sensor and/or an actuator with its own controller and driver, which is connected to the control device and the at least one driver device via the bus system.

15. A heating, ventilating and/or air-conditioning system for a motor vehicle, comprising:
a control device;
at least one driverless functional component; and
at least one driver device which is implemented physically separately from the control device and from the at least one driverless functional component,
wherein the control device is connected to the at least one driver device in terms of information technology by means of a bus system, the control device being configured to transmit control signals to the at least one driver device via the bus system, and
the driver device comprising at least one driver to operate the at least one driverless functional component, in response to receiving the control signals from the control device.
